(19) United States
(12) Patent Application Publication
(10) Pub. No.: US 2024/0283019 A1
(43) Pub. Date: Aug. 22, 2024

(54) SOLID ELECTROLYTE, ELECTRICITY STORAGE DEVICE AND METHOD FOR PRODUCING SOLID ELECTROLYTE

(71) Applicant: Nippon Chemi-Con Corporation, Shinagawa-ku, Tokyo (JP)

(72) Inventors: Yasuyoshi SHIRAISHI, Kanagawa (JP); Satoshi KUBOTA, Saitama (JP); Shuichi ISHIMOTO, Kanagawa (JP); Shun KOIKAWA, Osaka (JP)

(21) Appl. No.: 18/681,050

(22) PCT Filed: Aug. 1, 2022
(86) PCT No.: PCT/JP2022/029526

§ 371 Date: Feb. 3, 2024

(30) Foreign Application Priority Data
Aug. 3, 2021 (JP) 2021-127491

(51) Int. Cl. H01M 10/0565; H01G 11/06; H01G 11/22; H01G 11/56; H01G 11/84; H01M 10/0525

(52) U.S. Cl. CPC H01M 10/0565; H01G 11/06; H01G 11/22; H01G 11/56; H01G 11/84; H01M 10/0525; H01M 2300/0082

(57) ABSTRACT

Provided are a power storage device having good rate characteristics, a plastic crystal-type solid electrolyte used for this power storage device, and a method for manufacturing this solid electrolyte. The solid electrolyte includes a plastic crystal, a lithium salt, and a carbonate polymer or a derivative thereof. The carbonate polymer or a derivative thereof is contained in the solid electrolyte so that a proportion of a monomer unit of the carbonate polymer or a derivative thereof is 293 mol % or more and 782 mol % or less relative to the plastic crystal, and the lithium salt is contained in the solid electrolyte at a proportion of 75 mol % or more relative to the plastic crystal.

### FIELD OF INVENTION

The present disclosure relates to a solid electrolyte containing a plastic crystal, a power storage device using this solid electrolyte, and a method of manufacturing this solid electrolyte.

### BACKGROUND

Secondary batteries, electric double-layer capacitors, lithium-ion capacitors, fuel cells, solar cells, and other power storage devices are schematically constituted with positive and negative electrodes disposed opposite to each other with an electrolyte layer sandwiched therebetween. A lithium-ion secondary battery has a Faraday reaction electrode, and reversibly inserts and releases lithium ions in the electrolyte layer with the electrodes to charge and discharge electrical energy. In the electric double-layer capacitor, the positive electrode is a polarizable electrode, and utilizes a power storage function of an electric double layer formed on an interface between the polarizable electrode and the electrolyte layer, whereas the negative electrode is a Faraday reaction electrode, and reversibly inserts and releases lithium ions in the electrolyte layer with the electrodes to perform charge and discharge.

As the electrolyte layer in the power storage device, a solid electrolyte layer can be selected. The solid electrolyte layer limits a region of a chemical reaction of the electrode, such as hydrolytic deterioration, to a proximity of the electrode. Thus, the solid electrolyte layer reduces leakage current and inhibits self-discharge compared with an electrolyte liquid. Compared with the electrolyte liquid, the solid electrolyte layer also reduces a generation amount of gas derived from the chemical reaction with the electrode to reduce risks of vent opening and liquid leakage.

Known solid electrolytes include: sulfide-type solid electrolytes such as Li₂S·P₂S₅; oxide-type solid electrolytes such as Li₇La₃Zr₂O₁₂; plastic crystal-type solid electrolyte having, for example, N-ethyl-N-methylpyrrolidinium (P12) as a cation and bis(fluorosulfonyl)amide (FSA) as an anion; and polymer-type solid electrolytes such as polyethylene oxide. In the secondary battery, a selected matrix phase is doped with lithium ions as an electrolyte, if necessary. In the electric-double layer capacitor, a selected matrix phase is doped with, for example TEMABF₄, as an electrolyte, if necessary.

The plastic crystal is soluble in an organic solvent. Meanwhile, the sulfide- and oxide-type solid electrolytes are insoluble. Accordingly, when the plastic crystal is used as the solid electrolyte or a matrix phase of the solid electrolyte, a usable manufacturing method is a method in which an anionic component and cationic component, or their salt of the plastic crystal are dissolved in a solvent to be applied on the electrode. Thus, compared with the sulfide- and oxide-type solid electrolytes, the plastic crystal-type solid electrolyte has an advantage of increase in adhesiveness to the electrode and, when an active material phase of the electrode is a porous structure, easy permeation into the structure.

### PRIOR ART DOCUMENT

### Patent Document

Patent Literature 1: National Publication of International Patent Application No. 2014-504788
Patent Literature 2: Japanese Patent Laid-Open No. 2017-91813

### SUMMARY OF INVENTION

### Problems to be Solved by Invention

However, pointed out with the plastic crystal-type solid electrolyte is low ion conductivity over two to three orders compared with the sulfide- and oxide-type solid electrolytes. For example, a solid electrolyte containing a plastic crystal composed of an N,N-diethylpyrrolidinium cation and a bis(fluorosulfonyl)amide anion is reported to have an ion conductivity of 1×10⁻⁵ S/cm order under an environment at 25° C. A solid electrolyte containing a plastic crystal composed of an N,N-dimethylpyrrolidinium cation and a bis(trifluoromethanesulfonyl)amide anion is reported to have an ion conductivity of 1×10⁻⁸ S/cm order.

In contrast, for example, the solid electrolyte of Li₂S·P₂S₅ is reported to have an ion conductivity of 1×10⁻² S/cm order. For example, the solid electrolyte of Li₇La₃Zr₂O₁₂ is reported to have an ion conductivity of 1×10⁻³ S/cm order. Thus, as for the power storage device using a plastic crystal-type solid electrolyte, room for improvement of rate characteristics is pointed out.

The present invention has been proposed in order to solve the above problem, and an object thereof is to provide a power storage device having good rate characteristics, a plastic crystal-type solid electrolyte used for this power storage device, and a method of manufacturing this solid electrolyte.

### Means to Solve the Problem

To solve the above problem, a solid electrolyte according to the present invention comprises a plastic crystal, a lithium salt, and a carbonate polymer or a derivative thereof, wherein the carbonate polymer or a derivative thereof is contained so that a proportion of a monomer unit of the carbonate polymer or a derivative thereof is 293 mol % or more and 782 mol % or less relative to the plastic crystal, and the lithium salt is contained at a proportion of 75 mol % or more relative to the plastic crystal.

The solid electrolyte may contain two or more types of the plastic crystals.

The solid electrolyte may contain one type or two or more types of the plastic crystals, one type, a plurality of types, or all types of the plastic crystals may contain bis(fluorosulfonyl)amide, and the bis(fluorosulfonyl)amide may be contained at 20 mol % or more in anions of an entirety of the plastic crystal.

The solid electrolyte may further comprise a glycol diether compound or a cyclic ether compound.

The lithium salt may be an ion-dissociative salt.

The carbonate polymer may be one or two or more selected from polyethylene carbonate, polypropylene carbonate, polybutylene carbonate, polycyclohexene carbonate, polytrimethylene carbonate, polyhexamethylene carbonate, and bisphenol A-polycarbonate.

Another aspect of the present invention is a power storage device comprising both electrodes disposed opposite to each other with the solid electrolyte sandwiched therebetween.

To solve the above problem, a method of manufacturing a solid electrolyte according to the present invention comprises a step of mixing a plastic crystal, a lithium salt, and a carbonate polymer or a derivative thereof, wherein in the step, the carbonate polymer or a derivative thereof is contained so that a proportion of a monomer unit of the carbonate polymer or a derivative thereof is 293 mol % or more and 782 mol % or less relative to the plastic crystal, and in the step, the lithium salt is contained at a proportion of 75 mol % or more relative to the plastic crystal.

In the step, the plastic crystal, the lithium salt, and the carbonate polymer or a derivative thereof may be added to a polar solvent.

In the step, the plastic crystal, the lithium salt, and the carbonate polymer or a derivative thereof may be added to a mixed solvent of anisole and butyl butyrate.

### Effect of Invention

The power storage device using the solid electrolyte of the present invention has good rate characteristics.

### BRIEF DESCRIPTION OF DRAWINGS

FIG. 1 is a graph indicating a relationship between an amount of a lithium salt and a capacity retention at each C-rate.

FIG. 2 is a graph indicating a relationship between an amount of a carbonate polymer or a derivative thereof and a capacity retention at each C-rate.

FIG. 3 is a graph indicating a relationship between a proportion of an FSA anion and a capacity retention at each C-rate.

### EMBODIMENTS

Hereinafter, embodiments of the present invention will be described. The present invention is not limited to the embodiments described below.

### (Solid Electrolyte)

The solid electrolyte is interposed between positive and negative electrodes of a power storage device to conduct mainly ions. The power storage device, which is a passive element charging and discharging electrical energy, is, for example, a lithium-ion secondary battery, an electric double-layer capacitor, and the like. The Lithium-ion secondary battery has a Faraday reaction electrode, and reversibly inserts and releases lithium ions in the electrolyte layer with the electrodes to charge and discharge electrical energy. In the electric double-layer capacitor, the positive electrode is a polarizable electrode, and utilizes a power storage function of an electric double layer formed on an interface between the polarizable electrode and the electrolyte layer, whereas the negative electrode is a Faraday reaction electrode, and reversibly inserts and releases lithium ions in the electrolyte layer with the electrodes to perform charge and discharge.

This solid electrolyte has a matrix phase formed of the plastic crystal to be an ion-conductive medium, and contains a lithium salt with which the plastic crystal is doped. The solid electrolyte further contains a carbonate polymer or a derivative thereof. The plastic crystal has an ordered arrangement and a disordered arrangement. That is, the plastic crystal has a three-dimensional crystal lattice structure in which anions and cations are regularly arranged, and meanwhile, these anions and cations have rotation irregularity. The anion and cation to constitute the plastic crystal may be any known anions and cations as long as they do not form an ionic liquid and can maintain the solid state to constitute the plastic crystal within a temperature range of use for the power storage device.

Examples of the cation used for this plastic crystal include pyrrolidinium-type cations, spiro-pyrrolidinium-type cations, ammonium-type cations, phosphonium-type cations, and piperidinium-type cations.

The pyrrolidinium-type cation is represented by the following chemical formula (A), and is a five-membered ring cation to which a methyl group, an ethyl group, or an isopropyl group is bonded.

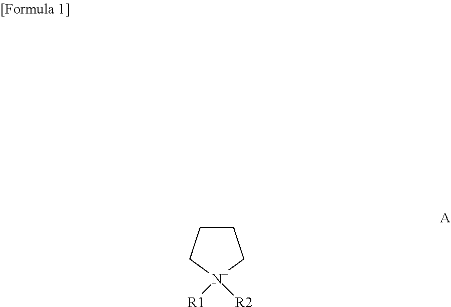

In the formula, R1 and R2 represent a methyl group, an ethyl group, or an isopropyl group.

Specific examples of the pyrrolidinium cations generalized by the chemical formula (A) include an N-ethyl-N-methylpyrrolidinium cation (P12 cation) represented by the following chemical formula (A1), a 1,1-dimethylpyrrolidinium (P11 cation) represented by the following chemical formula (A2), an N-isopropyl-N-methylpyrrolidinium cation (P13iso cation) represented by the following chemical formula (A3), and an N,N-diethylpyrrolidinium cation (P22 cation) represented by the following chemical formula (A4).

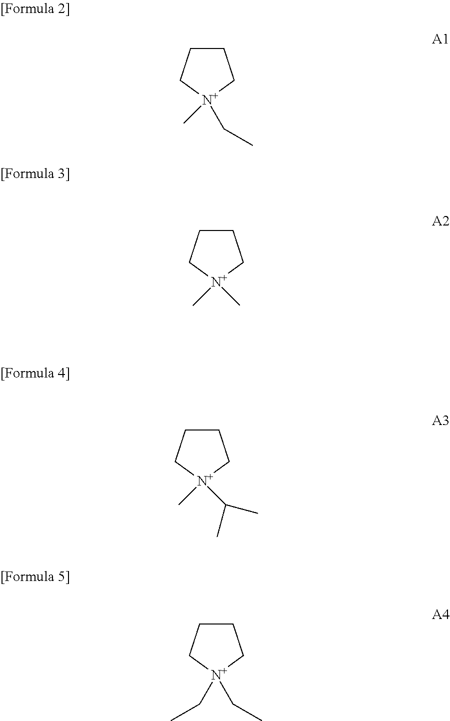

The spiro-pyrrolidinium-type cation (SBP cation) is represented by the following chemical formula (B).

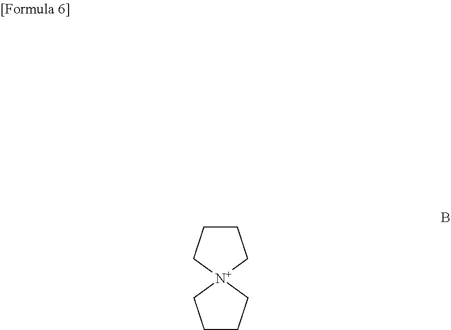

The ammonium-type cation is represented by the following chemical formula (C), and examples thereof include a tetraalkylammonium cation substituted with linear alkyl groups having any number of carbon atoms. Specific examples of the tetraalkylammonium cation include a triethylmethylammonium cation (TEMA cation) and a tetraethylammonium cation (TEA cation).

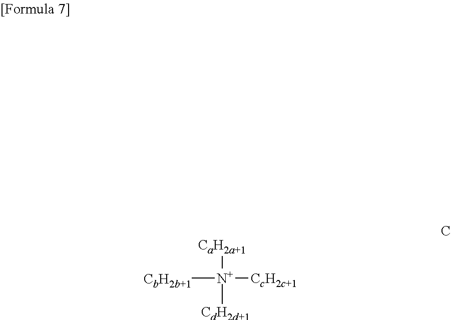

In the formula, a, b, c, and d represent integers of 1 or more, and the number of carbon atoms may be any number.

The phosphonium-type cation is represented by the following chemical formula (D), and examples thereof include a tetraalkylphosphonium cation substituted with linear alkyl groups having any number of carbon atoms. Examples of the tetraalkylphosphonium cation include a tetraethylphosphonium cation (TEP cation).

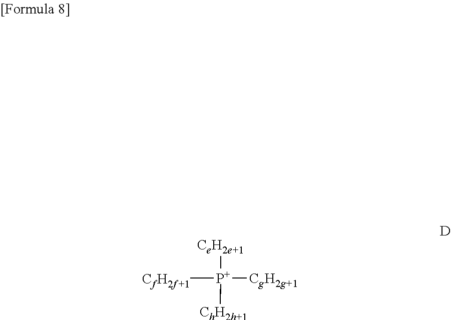

In the formula, e, f, g, and h represent integers of 1 or more, and the number of carbon atoms may be any number.

The piperidinium-type cation is represented by the following chemical formula (E), and is a six-membered ring cation to which a methyl group, an ethyl group, or an isopropyl group is bonded.

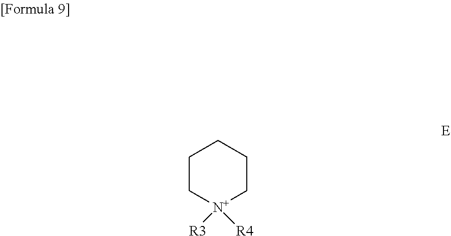

In the formula, R3 and R4 represent a methyl group, an ethyl group, or an isopropyl group.

Specific examples of the piperidiniums generalized by the chemical formula (E) include a 1-methyl-1-methylpiperidinium cation in which R3 and R4 both represent methyl groups, a 1-isopropyl-1-methylpiperidinium cation in which R3 represents an isopropyl group and R4 represents a methyl group, a 1-methyl-1-ethylpiperidinium cation in which R3 represents a methyl group and R4 represents an ethyl group, and a 1-ethyl-1-ethylpiperidinium cation in which R3 and R4 both represent ethyl groups.

Examples of the anion used for the plastic crystal include a bis(trifluoromethanesulfonyl)amide anion (TFSA anion) represented by the following chemical formula (F1), a bis(fluorosulfonyl)amide anion (FSA anion) represented by the following chemical formula (F2), a bis(pentafluoroethylsulfonyl)amide anion (BETA anion) represented by the following chemical formula (F3), an N,N-hexafluoro-1,3-disulfonylamide anion (CFSA anion) represented by the following chemical formula (F4), a tris(trifluoromethanesulfonyl)methanide anion (TFSM anion) represented by the following chemical formula (G), a tris(pentafluoroethyl)trifluorophosphate anion (FAP anion) represented by the following chemical formula (H), PF6, BF₄, and CF₃BF₃.

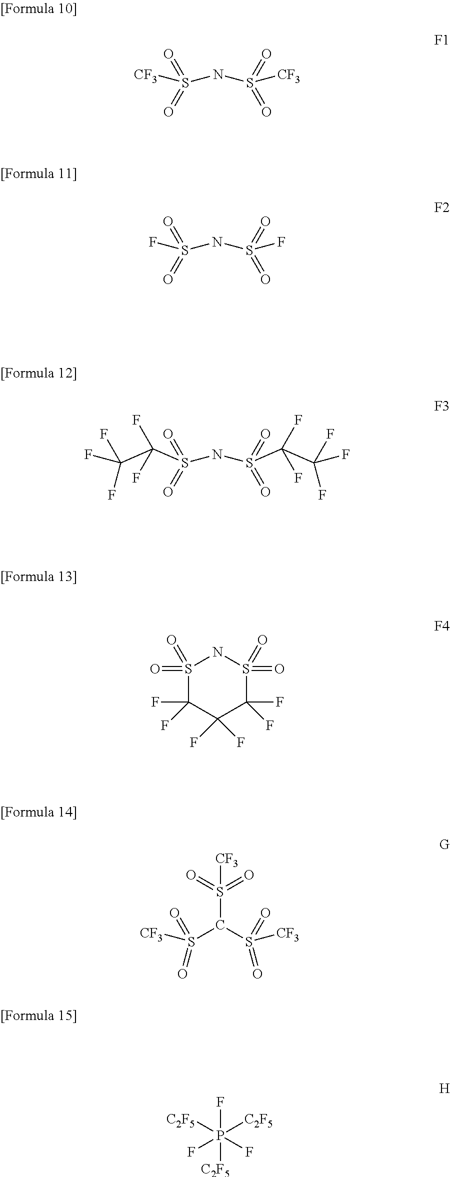

The solid electrolyte further contains a lithium salt with which the plastic crystal is doped. The lithium salt is an ion-dissociative salt. In the plastic crystal, positive ions and negative ions generated by dissociation of the lithium salt hop with rotation of the anions and cations to move through gaps in the crystal lattice. Examples of such a lithium salt include Li (CF₃SO₂)₂N (commonly called: LiTFSA), Li (FSO₂)₂N (commonly called: LiFSA), Li (C₂F₅SO₂)₂N, LiPF₆, LiBF₄, LiAsF₆, LiTaF₆, LiClO₄, and LiCF₃SO₃.

The solid electrolyte contains a carbonate polymer or a derivative thereof. The carbonate polymer is represented by the following chemical formula (I), and composed by polymerizing a monomer having a carbonate group and an alkylene group. The carbonate polymer may have a form of a homopolymer, or may be present as a copolymer of two or more types of monomers.

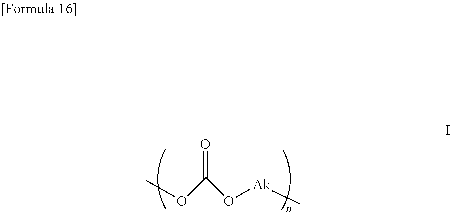

In the formula, Ak represents an alkylene group.

Examples of this carbonate polymer include polyethylene carbonate (PEC) represented by the following chemical formula (I), polypropylene carbonate (PPC) represented by the following chemical formula (12), polybutylene carbonate (PBC) represented by the following chemical formula (13), polycyclohexene carbonate (PCC) represented by the following chemical formula (14), polytrimethylene carbonate (PTMC) represented by the following chemical formula (15), and polyhexamethylene carbonate (PHMC) represented by the following chemical formula (16).

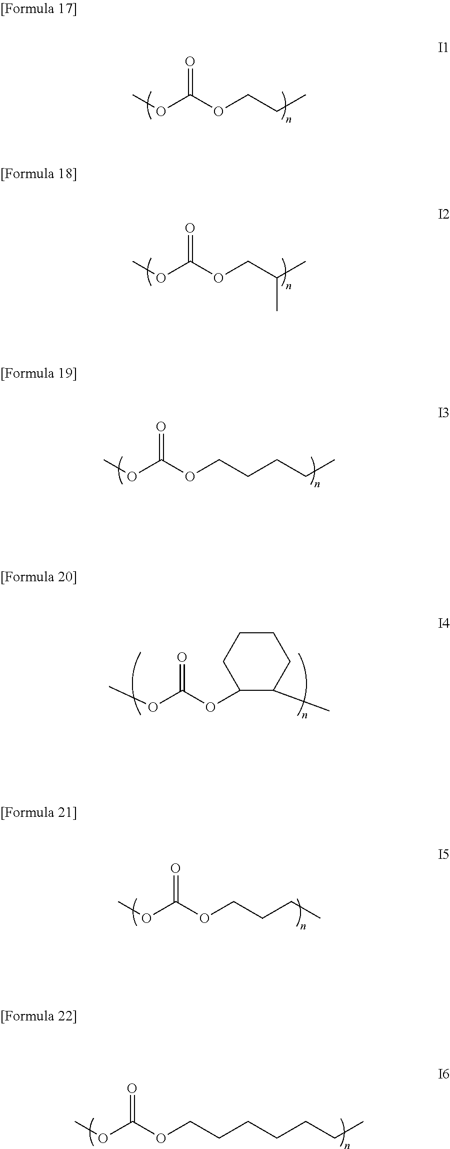

Alternatively, examples of the carbonate polymer include bisphenol A-polycarbonate represented by the following chemical formula (J).

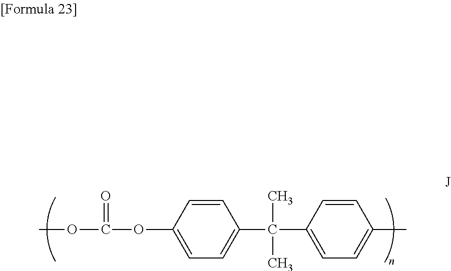

Examples of the derivative of the carbonate polymer include a compound in which a carbon to be a main chain of the alkylene group shown in the chemical formula (I) is substituted with, for example, a methyl group, an ethyl group, a propyl group, an isopropyl group, a hydroxy group, an aldehyde group, a carboxyl group, or an amino group as a side chain.

In the solid electrolyte having the above composition, the carbonate polymer or a derivative thereof is contained so that a proportion of the monomer unit is 293 mol % or more and 782 mol % or less relative to the plastic crystal. The lithium salt is contained in the solid electrolyte at a proportion of 75 mol % or more relative to the plastic crystal. Use of this solid electrolyte for the power storage device yields good rate characteristics. Specifically, the discharge capacity can be increased from a low C-rate of 0.1 C and 10 C to a high C-rate, for example.

This reason is presumed as follows but not limited to this mechanism. That is, the carbonate polymer or a derivative thereof contained in the solid electrolyte so that a proportion of the monomer unit is 293 mol % or more and 782 mol % or less relative to the plastic crystal widens a distance between lattices of the plastic crystal to improve ion diffusability. Meanwhile, the polycarbonate group is a functional group not strongly binding lithium ions generated by dissociation of the lithium salt, and thereby the carbonate polymer or a derivative thereof contained in the solid electrolyte at an amount within this range does not inhibit move of the lithium ions in the solid electrolyte. From these two reasons, the lithium salt contained in the solid electrolyte at a proportion of 75 mol % or more relative to the plastic crystal facilitates for the lithium ions to hopping move in the plastic crystal, resulting in the good rate characteristics.

Note that “1 C” in the C-rate means a cycle in which the power storage device is charged over one hour and discharged over one hour. That is, 0.1 C means a cycle in which the power storage device is charged over 10 hours and discharged over 10 hours, and 10 C means a cycle in which the power storage device is charged over 1/10 hour, namely 6 minutes, and discharged over 1/10 hour, namely 6 minutes.

As for each of the plastic crystal, the lithium salt, and the carbonate polymer or a derivative thereof, one type or two or more types may be combined for use in the solid electrolyte. That is, in combination of the anion component and the cation component, two or more types of the plastic crystals in which one or both of the components are different may be contained in the solid electrolyte. In combination of the positive ion component and the negative ion component, two or more types of the lithium salts in which one or both of the components are different may be contained in the solid electrolyte. Regarding the carbonate polymer or a derivative thereof, the polymers may have a form of homopolymers, or may be present as a copolymer of two or more types of monomers. When two or more types of the monomers are present, the monomers are contained in the solid electrolyte so that a total value of determined proportions of the contained monomer unit having the carbonate group relative to the plastic crystal is 293 mol % or more and 782 mol % or less relative to the plastic crystal.

The solid electrolyte preferably contains two or more types of the plastic crystals. The solid electrolyte containing two or more types of the plastic crystals yields further better rate characteristics when the solid electrolyte is used for the power storage device. The anion to constitute the plastic crystal is preferably bis(fluorosulfonyl)amide (FSA), and a proportion of the FSA anion is preferably 20 mol % or more in all of the anions. Use of these solid electrolytes for the power storage device yields further better rate characteristics. Particularly, the proportion of the FSA anion is preferably 50 mol % or more and 70 mol % or less, and more preferably 50 mol % or more and 60 mol % or less in all of the anions to constitute the plastic crystal. Such a proportion yields particularly good rate characteristics.

The matrix phase of the solid electrolyte is preferably composed of only the plastic crystal. For example, containing a mixture of an ionic liquid and the plastic crystal as an electrolyte deteriorates the good rate characteristics by containing the carbonate polymer or a derivative thereof in the solid electrolyte so that a proportion of the monomer unit is 293 mol % or more and 782 mol % or less relative to the plastic crystal and by containing the lithium salt in the solid electrolyte at a proportion of 75 mol % or more relative to the plastic crystal.

The solid electrolyte preferably contains a glycol diether compound, which is called as a glyme, or a cyclic ether compound. Use of the solid electrolyte containing these compounds for the power storage device yields good rate characteristics. The glycol diether compound is composed of ether bonds of alkyl groups with hydroxy groups at both terminals of glycols, and examples thereof include triethylene glycol dimethyl ether represented by the following chemical formula (K1) and tetraethylene glycol dimethyl ether represented by the following chemical formula (K2). The cyclic ether compound is also called as crown ether, represented by the general structural formula (—CH₂—CH₂—O—)ₙ, and examples thereof include 12-crown-4-ether represented by the following chemical formula (L1), 15-crown-5-ether represented by the following chemical formula (L2), and 18-crown-6-ether represented by the following chemical formula (L3).

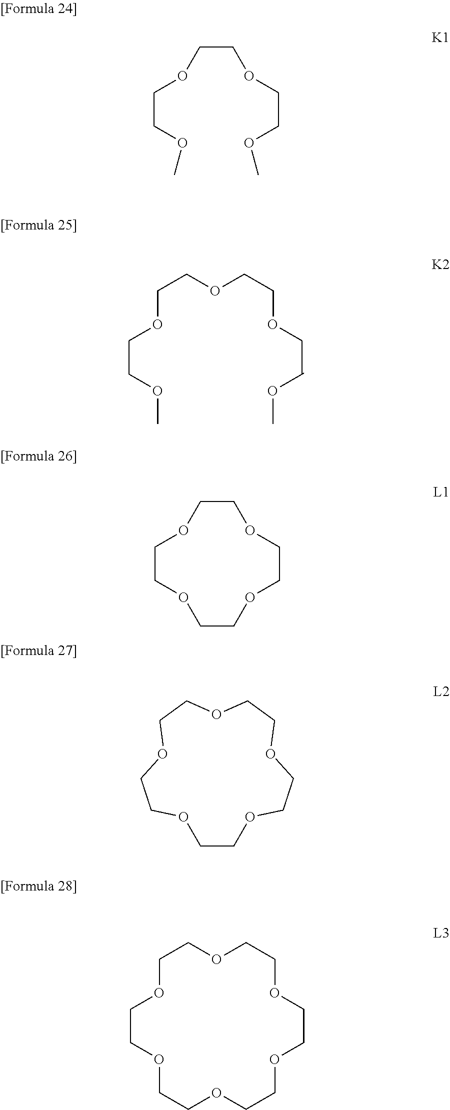 [SMILES: COCCOCCOCCOC ; COCCOCCOCCOCC(C)OC ; C1COCCOCCOCCO1 ; C1COCCOCCOCCOCCO1 ; C1COCCOCCOCCOCCOCCO1]

The glycol diether compound or the cyclic ether compound forms a complex with the lithium ion generated by dissociation of the lithium salt. The formation of the complex weakens an interaction between the lithium ion and the anion in the plastic crystal, and thereby the lithium ion easily hopping-moves in the plastic crystal. Meanwhile, since the distance between lattices of the plastic crystal is widened by containing the carbonate polymer or a derivative thereof in the solid electrolyte so that a proportion of the monomer unit is 293 mol % or more and 782 mol % or less relative to the plastic crystal even with the formation of the complex, the diffusibility is not inhibited even with the formation of the complex. Thus, it is considered that further better rate characteristics are obtained.

An example of a method of manufacturing the solid electrolyte containing such a plastic crystal is as follows. Each of an alkali metal salt of anion and a halogenated cation that are to constitute the plastic crystal is dissolved in a solvent. Examples of the alkali metal include Na, K, Li, and Cs. Examples of the halogen include F, Cl, Br, and I. The solvent is preferably water. Into the solution of the halogenated cation, the solution of the metal salt of the anion is gradually dropped to perform an ion-exchange reaction. An equivalent amount of moles of the solution of the metal salt of the anion is added into the solution of the halogenated cation, and the mixture is stirred.

In this time, a plastic crystal is generated and a halogenated alkali metal is generated by the ion-exchange reaction. Since the plastic crystal is hydrophobic and the halogenated alkali metal is hydrophilic, the plastic crystal is present as a solid state in the aqueous solution and the halogenated alkali metal is dissolved in the aqueous solution. With this aqueous solution in which the plastic crystal is present in the solid state, an organic solvent such as dichloromethane is mixed. The organic solvent such as dichloromethane is mixed and left to stand, and the mixed liquid is separated into an aqueous layer and an organic solvent layer.

The aqueous layer is removed from the separated liquid to remove the halogenated alkali metal. This procedure is repeated a plurality of times such as five times. The halogenated alkali metal is removed by this procedure, and then the organic solvent such as dichloromethane is evaporated to obtain the plastic crystal. When the aqueous solution is left to stand without mixing with the organic solvent such as dichloromethane, a precipitate of the plastic crystal is obtained. Thus, this precipitate may be recovered by filtering, washed with water, and the dry in vacuo.

The solid electrolyte containing two or more types of the plastic crystal may be obtained by the same manufacturing method as the second type of the plastic crystal. That is, each of an alkali metal salt and a halogenated cation is dissolved in a solvent, an ion-exchange reaction is performed by dropping, and an organic solvent such as dichloromethane is mixed to remove an aqueous layer. Each of the plastic crystals is purified, and added into a vial bottle at a predetermined molar ratio.

The lithium salt, and the carbonate polymer or a derivative thereof, which are to be the electrolyte, are added into the vial bottle. Then, the plastic crystal, and a solvent that dissolves the lithium salt and the carbonate polymer or a derivative thereof are further added into the vial bottle to prepare a solution in which the plastic crystal, the lithium salt, and the carbonate polymer or a derivative thereof are dissolved. The solvent is preferably a polar solvent, and the polar solvent is contained in the solvent at 50 wt % or more. Examples of the polar solvent include acetonitrile, propylene carbonate, γ-butyrolactone, dimethyl carbonate, ethyl methyl carbonate, ethylene carbonate, sulfolane, and a mixture thereof. Into these polar solvents, the plastic crystal, the lithium salt, and the carbonate polymer or a derivative thereof are efficiently dissolved, resulting in excellent productivity of the solid electrolyte. When polypropylene carbonate is used as the carbonate polymer or a derivative thereof, a mixed solvent of anisole and butyl butyrate, which is a nonpolar solvent, may also be used. This nonpolar solvent also sufficiently dissolves the plastic crystal, the lithium salt, and polypropylene carbonate. In the solvent, anisole and butyl butyrate are contained at 50 wt % or more in total.

This solution is applied on a target of an electrode to which the solid electrolyte adheres, such as an active material layer, a separator, or both of them. After the application, the applied solution is left under a temperature environment in which the solvent is evaporated, such as 80° C., for drying to volatilize the solvent. Furthermore, a remained moisture and the like are volatilized under a temperature environment such as 150° C. This procedure forms the solid electrolyte on the target.

Note that the solvent is further preferably propylene carbonate, γ-butyrolactone, ethylene carbonate, or a mixed solvent of anisole and butyl butyrate. Use of these solvents reduces an amount of bubbles in a layer of the solid electrolyte. Thus, a capacity of the power storage device can be increased while skipping a bubble removing step, and productivity of the power storage device becomes excellent.

### (Power Storage Device)

The power storage device is produced by disposing positive and negative electrodes opposite to each other with sandwiching the solid electrolyte. In order to prevent contact between the positive and negative electrodes and maintain the form of the solid electrolyte, a separator is interposed between the positive and negative electrodes. When the solid electrolyte has a thickness that can prevent the contact between the positive and negative electrodes and has a hardness that can maintain the form by itself, the device may be a so-called separator-less device.

When the power storage device is a lithium-ion secondary battery, positive and negative electrodes of the lithium-ion secondary battery are produced by forming an active material layer on a current collector. As the current collector, metals such as aluminum foil, platinum, gold, nickel, titanium, and steel; carbon; conductive polymer materials such as polyaniline, polypyrrole, polythiophene, polyacetylene, polyparaphenylene, polyphenylenevinylene, polyacrylonitrile, and polyoxadiazole; or resins in which a non-conductive polymer material is filled with a conductive filler can be used. Any shape of the current collector, such as film, foil, plate, web, expand metal, and cylinder, may be used.

The active material is mixed with the binder to be applied on the current collector with a doctor blade method or the like. A mixture of the carbon material and the binder may be formed into a sheet to be crimped on the current collector. Into the active material layer, a conductive carbon to be a conductive auxiliary such as carbon black, acetylene black, Ketjenblack, and graphite may be added. The conductive auxiliary is kneaded in addition to the active material and the binder to be applied or crimped on the current collector.

Examples of an active material of the positive electrode include metal compound particles that can occlude and release lithium ions, and include layered rock-salt LiMO₂, a layered solid solution of Li₂MnO₃—LiMO₂, and spinel LiM₂O₄ (in the formulas, M means Mn, Fe, Co, Ni, or a combination thereof). Specific examples thereof include LiCoO₂, LiNiO₂, LiNi_{4/5}Co_{1/5}O₂, LiNi_{1/3}Co_{1/3}Mn_{1/3}O₂, LiNi_{1/2}Mn_{1/2}O₂, LiFeO₂, LiMnO₂, Li₂MnO₃—LiCoO₂, Li₂MnO₃—LiNiO₂, Li₂MnO₃—LiNi_{1/3}Co_{1/3}Mn_{1/3}O₂, Li₂MnO₃—LiNi_{1/2}Mn_{1/2}O₂, Li₂MnO₃—LiNi_{1/2}Mn_{1/2}O₂—LiNi_{1/3}Co_{1/3}Mn_{1/3}O₂, LiMn₂O₄, and LiMn_{3/2}Ni_{1/2}O₄. Examples of the metal compound particles include: sulfur; sulfides such as Li₂S, TiS₂, MoS₂, FeS₂, VS₂, and Cr_{1/2}V_{1/2}S₂; selenides such as NbSe₃, VSe₂, and NbSe₃; oxides such as Cr₂O₅, Cr₃O₈, VO₂, V₃O₈, V₂O₅, and V₆O₁₃; and in addition, composite oxides such as LiNi_{0.8}Co_{0.15}Al_{0.05}O₂, LiVOPO₄, LiV₃O₅, LiV₃O₈, MoV₂O₈, Li₂FeSiO₄, Li₂MnSiO₄, LiFePO₄, LiFe_{1/2}Mn_{1/2}PO₄, LiMnPO₄, and Li₃V₂(PO₄)₃.

Examples of the active material of the negative electrode include metal compound particles, carbon materials, or conductive polymers that can occlude and release lithium ions. Examples of the metal compound particles include: oxides such as FeO, Fe₂O₃, Fe₃O₄, MnO, MnO₂, Mn₂O₃, Mn₃O₄, CoO, CO₃O₄, NiO, Ni₂O₃, TiO, TiO₂, TiO₂(B), CuO, NiO, SnO, SnO₂, SiO₂, RuO₂, WO, WO₂, WO₃, MoO₃, and ZnO; metals such as Sn, Si, Al, and Zn; composite oxides such as LiVO₂, Li₃VO₄, Li₄Ti₅O₁₂, Sc₂TiO₅, and Fe₂TiO₅; nitrides such as Li_{2.6}Co_{0.4}N, Ge₃N₄, Zn₃N₂, and Cu₃N; and Y₂Ti₂O₅S₂ and MoS₂. Examples of the carbon materials include artificial graphite, natural graphite, hard carbon, and soft carbon. Examples of the conductive polymer include polyacene, polyacetylene, polyphenylene, polyaniline, and polypyrrole.

When the power storage device is an electric double-layer capacitor, the positive electrode is produced by forming an active material layer on a current collector, similarly to the lithium-ion secondary battery. The active material is metal compound particles that can occlude and release lithium ions. The negative electrode is produced by forming an active material layer of a polarizable electrode on a current collector. An active material layer of the polarizable electrode contains a porous-structured carbon material having an electric double-layer capacity. For the electric double-layer capacitor having the porous-structured active material layer, the solid electrolyte using this plastic crystal is particularly preferable. Since being soluble, the plastic crystal easily permeates into the porous structure to increase a filling rate into the active material layer. Meanwhile, a sulfide- and oxide-type solid electrolytes have lower filling property into the porous structure. Thus, the electric double-layer capacitor using this plastic crystal can achieve both of the good filling property into the porous structure and the high ion conductivity, and thereby has a large capacity and high output.

The carbon material in the polarizable electrode is mixed with a conductive auxiliary and a binder to be applied on the current collector with a doctor blade method or the like. A mixture of the carbon material, the conductive auxiliary, and the binder may be formed into a sheet to be crimped on the current collector. When the carbon material has a particle shape, the porous structure is composed of gaps generated between primary particles and between secondary particles. When the carbon material is fibric, the porous structure is composed of gaps between the fibers.

Examples of the carbon material in the active material layer of the polarizable electrode include natural plant tissues such as a coconut shell, synthetic resins such as phenol, active carbons made from a raw material derived from fossil fuel such as coal, coke, and pitch, carbon blacks such as Ketjenblack, acetylene black, and channel black, carbon nanohorn, amorphous carbon, natural graphite, artificial graphite, graphitized Ketjenblack, mesoporous carbon, carbon nanotube, and carbon nanofiber. A specific surface area of this carbon material may be increased by an activation treatment such as steam activation, alkaline activation, zinc-chloride activation, and electric field activation, and by an opening treatment.

Examples of the binder include: rubbers such as fluorine rubber, diene rubber, and styrene rubber; fluorine-containing polymers such as polytetrafluoroethylene and polyvinylidene fluoride; celluloses such as carboxymethylcellulose and nitrocellulose; and other materials such as a polyolefin resin, a polyimide resin, an acrylic resin, a nitrile resin, a polyester resin, a phenolic resin, a polyvinyl acetate resin, a polyvinyl alcohol resin, and an epoxy resin. These binders may be used singly, and may be used with mixing two or more thereof.

For the conductive auxiliary, Ketjenblack, acetylene black, natural or artificial graphite, fibric carbon, and the like can be used, and examples of the fibric carbon include fibric carbons such as carbon nanotube and carbon nanofiber (hereinafter, CNF). The carbon nanotube may be single-wall carbon nanotube (SWCNT), which has one layer of graphene sheet, may be multi-wall carbon nanotube (MWCNT), which has two or more layers of graphene sheet coaxially round to from a multilayered tube wall, and may be a mixture thereof.

A carbon-coating layer containing a conductive agent such as graphite may be provided between the current collector and the active material layer. The carbon-coating layer may be formed by applying a slurry containing the conductive agent such as graphite, a binder, and the like on the surface of the current collector to be dried.

When the separator is used in the power storage device, examples of the separator include celluloses such as kraft, Manila hemp, esparto, hemp, and rayon, and a mixed paper thereof, polyester resins such as polyethylene terephthalate, polybutylene terephthalate, and polyethylene napthalate, and a derivative thereof, a polytetrafluoroethylene resin, a polyvinylidene fluoride resin, a vinylon resin, polyamide resins such as an aliphatic polyamide, a semi-aromatic polyamide, and a wholly aromatic polyamide resin, a polyimide resin, a polyethylene resin, a polypropylene resin, a trimethylpentene resin, a polyphenylene sulfide resin, and an acrylic resin. These resins may be used singly or with mixed.

### EXAMPLES

### Examples 1 to 4

Solid electrolytes of Examples 1 to 4 were produced. For these solid electrolytes, two types of plastic crystals were used. The first type of the plastic crystal was a [P12][FSA] plastic crystal in which a cation component was constituted with an N-ethyl-N-methylpyrrolidinium cation (P12 cation) and an anion component was constituted with a bis(fluorosulfonyl)amide anion (FSA anion), and the plastic crystal contained the P12 cation and the FSA anion at a molar ratio of 1:1. The second type of the plastic crystal was a [P12][TFSA] plastic crystal in which a cation component was constituted with the P12 cation and an anion component was constituted with a bis(trifluoromethanesulfonyl)amide anion (TFSA anion), and the plastic crystal contained the P12 cation and the TFSA anion at a molar ratio of 1:1. These [P12][FSA] plastic crystal and the [P12][TFSA] plastic crystal were added into a vial bottle at a molar ratio of 1:1.

Into the vial bottle, LiTFSA and polyethylene carbonate (PEC) were further added. In the vial bottle, these plastic crystals, the lithium salt, and the carbonate polymer were dissolved in acetonitrile.

This acetonitrile solution was added dropwise to a separator, an electrode for a negative electrode, and an electrode for a positive electrode, and dried under a vacuum environment at 50° C. for 2 hours to evaporate acetonitrile. The electrode for the negative electrode had a current collector being copper foil, and an active material layer formed on the current collector and containing graphite. The electrode for the positive electrode had a current collector being aluminum foil, and an active material layer formed on the current collector and containing Li₁Ni_{0.6}Co_{0.2}Mn_{0.2}O₂. The separator was sandwiched between the electrode for the negative electrode and the electrode for the positive electrode to produce a cell, and this cell was dried under a vacuum environment at 100° C. for 12 hours. Then, this cell was sealed with a laminated cell to complete a lithium-ion secondary battery.

A plurality of types of this lithium-ion secondary battery was completed. The lithium-ion secondary batteries were common in terms of the solid electrolyte containing polyethylene carbonate (PEC) so that a proportion of a monomer unit of the polyethylene carbonate (PEC) was 390.9 mol % relative to a total of the plastic crystal. Meanwhile, amounts of LiTFSA contained in the solid electrolyte differed as shown in the following Table 1. In the following Table 1, the amount of LiTFSA is an amount added relative to the total of the plastic crystal.

TABLE 1

| | Amount of LiTFSA |
|---|---|
| | added relative to |
| | plastic crystal/mol % |
| Comparative | 30 |
| Example 1 | |
| Comparative | 50 |
| Example 2 | |
| Example 1 | 75 |
| Example 2 | 100 |
| Example 3 | 150 |
| Example 4 | 200 |

Each of these lithium-ion secondary batteries was charged and discharged at a C-rate of 0.1 C or 10 C to measure a discharge capacity. Then, a ratio between the discharge capacity and a reference capacity was calculated to calculate a capacity retention at each C-rate of each of the lithium-ion secondary batteries.

Here, used for the reference capacity was a discharge capacity when a reference lithium-ion secondary battery using an electrolyte liquid was produced as follows and this secondary battery was charged and discharged at a C-rate of 0.1 C. The reference lithium-ion secondary battery had an electrode for a positive electrode and an electrode for a negative electrode same as of the lithium-ion secondary battery using the solid electrolyte with the plastic crystal. Note that the reference lithium-ion secondary battery had the electrolyte liquid, not the solid electrolyte with the plastic crystal. In this electrolyte liquid, a solvent was a mixed liquid of ethylene carbonate and dimethyl carbonate at the same amounts, LiPF₆ was added at 1 M into this solvent, and vinylene carbonate was further added at 1 wt % into the solvent. As a result, the reference capacity was 142 mAh/g. Note that a discharge capacity of the reference lithium-ion secondary battery charged and discharged at 10 C was 101.2 mAh/g.

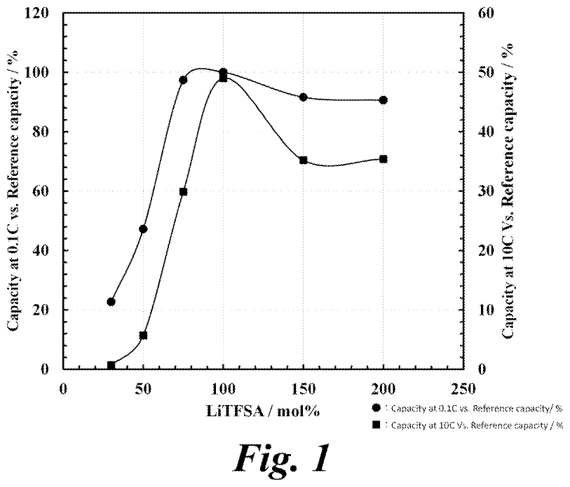

The following Table 2 shows the capacity retention of each of the lithium-ion secondary batteries. Based on the following Table 2, a graph of FIG. 1 indicates a relationship between the amount of the lithium salt and the capacity retention at each C-rate.

TABLE 2

| | Amount of LiTFSA | Capacity | Capacity |
|---|---|---|---|
| | added relative to | retention | retention |
| | plastic crystal/mol % | at 0.1 C/% | at 10 C/% |
| Comparative | 30 | 22.7 | 0.7 |
| Example 1 | | | |
| Comparative | 50 | 47.2 | 5.7 |
| Example 2 | | | |
| Example 1 | 75 | 97.4 | 29.9 |
| Example 2 | 100 | 100 | 49.0 |
| Example 3 | 150 | 91.6 | 36.2 |
| Example 4 | 200 | 90.6 | 35.4 |

As shown in Table 2 and FIG. 1, when the proportion of the monomer unit of the carbonate polymer was 390.9 mol %, which was within the range of 293 mol % or more and 782 mol % or less, relative to the plastic crystal, and when the amount of the lithium salt was 75 mol % or more relative to the plastic crystal, it was confirmed that the capacity retention was more than 90% at 0.1C, which was increased and comparable to the reference capacity. When the amount of the lithium salt was 75 mol % or more relative to the plastic crystal, it was confirmed that the capacity retention at 10 C was drastically increased.

### Examples 5 to 9

Next, lithium-ion secondary batteries were produced by using solid electrolytes of Examples 5 to 9. These lithium-ion secondary batteries had the same constitution as the solid electrolyte and both the electrodes in Examples 1 to 4. Note that, in each of the additional lithium-ion secondary batteries, the solid electrolyte contained LiTFSA at 100 mol % relative to a total of the plastic crystal, and amounts of polyethylene carbonate were different as shown in the following Table 3. In the following Table 3, the amount of the polyethylene carbonate is described as an amount of the monomer unit of the polyethylene carbonate relative to the total of the plastic crystal.

TABLE 3

| | Amount of PEC |
|---|---|
| | added relative to |
| | plastic crystal/mol% |
| Comparative | 39.1 |
| Example 4 | |
| Comparative | 117.3 |
| Example 5 | |
| Comparative | 195.51 |
| Example 6 | |
| Example 5 | 293.2 |
| Example 6 | 390.9 |
| Example 7 | 488.6 |
| Example 8 | 586.4 |
| Example 9 | 781.8 |
| Comparative | 977.3 |
| Example 7 | |

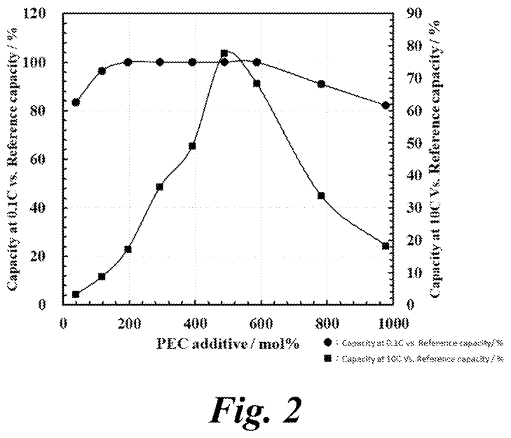

Each of these lithium-ion secondary batteries was charged and discharged at a C-rate of 0.1 C or 10 C to measure a discharge capacity. Then, a ratio between the discharge capacity and a reference capacity was calculated to calculate a capacity retention at each C-rate of each of the lithium-ion secondary batteries. The following Table 4 shows the result. Based on the following Table 4, a graph of FIG. 2 indicates a relationship between the amount of the carbonate polymer or a derivative thereof and the capacity retention at each C-rate.

TABLE 4

| | Amount of PEC | Capacity | Capacity |
|---|---|---|---|
| | added relative to | retention | retention |
| | plastic crystal/mol % | at 0.1 C/% | at 10 C/% |
| Comparative | 39.1 | 83.5 | 3.2 |
| Example 4 | | | |
| Comparative | 117.3 | 96.4 | 8.7 |
| Example 5 | | | |
| Comparative | 195.5 | 100.0 | 17.2 |
| Example 6 | | | |
| Example 5 | 293.2 | 100.0 | 36.4 |
| Example 6 | 390.9 | 100.0 | 49.0 |
| Example 7 | 488.6 | 100.0 | 77.7 |
| Example 8 | 586.4 | 100.0 | 68.5 |
| Example 9 | 781.8 | 91.0 | 33.7 |
| Comparative | 977.3 | 82.4 | 18.3 |
| Example 7 | | | |

As shown in Table 4 and FIG. 2, even when the amount of the lithium salt was 75 mol % or more relative to the plastic crystal and if the proportion of the monomer unit of the carbonate polymer was 195.5 mol % or less or 977.3 mol % or more relative to the plastic crystal, it was confirmed that the capacity at 10 C increased compared with the reference capacity was considerably decreased. In other words, when the proportion of the monomer unit of the carbonate polymer was 293.2 mol % or more and 781.8 mol % or less relative to the plastic crystal, it was confirmed that the capacity retention at 10 C was drastically increased.

With collectively considering Examples 1 to 9, when the plastic crystal, the lithium salt, and the carbonate polymer or a derivative thereof were contained, when the carbonate polymer or a derivative thereof were contained so that the proportion of its monomer unit was 293 mol % or more and 782 mol % or less relative to the plastic crystal, and when the lithium salt was contained at the proportion of 75 mol % or more relative to the plastic crystal, the capacity retention was 90% or more at 0.1 C and the high capacity retention was achieved even at 10 C, and it was confirmed that good rate characteristics were exhibited.

### Examples 10 to 17

Next, lithium-ion secondary batteries using solid electrolytes of Examples 10 to 17 with changing a mixing ratio (molar ratio) between the [P12][FSA] plastic crystal and the [P12][TFSA] plastic crystal so that the proportion of the [P12][TFSA] plastic crystal was from 20% to 100% by 10%, and a capacity retention at each C-rate was measured. The constitution was same as of the above lithium-ion secondary batteries except for the mixing ratio of the two types of the plastic crystals. The solid electrolyte contained LiTFSA at a proportion of 100 mol % relative to the plastic crystal, and the solid electrolyte contained polyethylene carbonate so that the proportion of its monomer unit was 586.4 mol % relative to the plastic crystal.

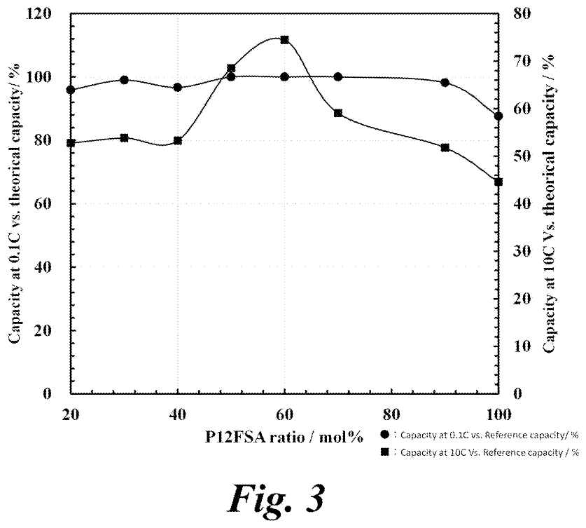

The following Table 5 shows a relationship between the mixing ratio of the [P12][FSA] plastic crystal and the capacity retention at 0.1 C and the capacity retention at 10 C. Based on the following Table 5, a graph of FIG. 3 indicates a relationship between the mixing ratio of the [P12][FSA] plastic crystal and the capacity retention at each C-rate.

TABLE 5

| | Proportion of [P12][FSA] | Capacity | Capacity |
|---|---|---|---|
| | in blending percentage of | retention | retention |
| | plastic crystal/mol % | at 0.1 C/% | at 10 C/% |
| Example 10 | 20 | 95.9 | 52.8 |
| Example 11 | 30 | 99.0 | 53.8 |
| Example 12 | 40 | 96.7 | 53.3 |
| Example 13 | 50 | 100.0 | 68.5 |
| Example 14 | 60 | 100.0 | 74.4 |
| Example 15 | 70 | 100.0 | 59.1 |
| Example 16 | 90 | 98.2 | 51.8 |
| Example 17 | 100 | 87.6 | 44.6 |

As shown in Table 5 and FIG. 3, when the proportion of the FSA anion was 20 mol % or more in all of the anions to constitute the plastic crystal, it was confirmed that the capacity retention at a C-rate of 10 C was good. In particular, when the proportion of the FSA anion was 50 mol % or more and 70 mol % or less in all of the anions to constitute the plastic crystal, it was confirmed that the capacity retention at a C-rate of 10 C was further better. Further, when the proportion of the FSA anion was 50 mol % or more and 60 mol % or less in all of the anions to constitute the plastic crystal, it was confirmed that the capacity retention at a C-rate of 10 C was remarkably better.

### Examples 18 to 22

Lithium-ion secondary batteries were produced by using solid electrolytes of Examples 18 to 22. The solid electrolytes of Examples 18 to 22 used one type of the plastic crystal. The solid electrolyte of Example 18 contained the [P12][FSA] plastic crystal, LiTFSA at 100 mol % relative to the plastic crystal, and polyethylene carbonate (PEC) at 390.9 mol % relative to the plastic crystal. The solid electrolyte of Example 19 contained the [P12][FSA] plastic crystal, LiTFSA at 100 mol % relative to the plastic crystal, and polyethylene carbonate (PEC) so that the proportion of the monomer unit was 586.4 mol % relative to the plastic crystal.

The solid electrolyte of Example 20 contained the [P12][FSA] plastic crystal, LiTFSA at 100 mol % relative to the plastic crystal, and polypropylene carbonate (PPC) so that the proportion of the monomer unit was 586.4 mol % relative to the plastic crystal.

The solid electrolyte of Example 21 contained a [TEMA][FSA] plastic crystal composed of a triethylmethylammonium cation (TEMA cation) and an FSA anion, LiTFSA at 100 mol % relative to the plastic crystal, and polyethylene carbonate (PEC) so that the proportion of the monomer unit was 586.4 mol % relative to the plastic crystal. The solid electrolyte of Example 22 contained an [SBP][FSA] plastic crystal composed of a spiro-pyrrolidinium-type cation (SBP cation) and an FSA anion, LiTFSA at 100 mol % relative to the plastic crystal, and polyethylene carbonate (PEC) so that the proportion of the monomer unit was 586.4 mol % relative to the plastic crystal.

Capacity retentions of the lithium-ion secondary batteries using these solid electrolytes of Examples 18 to 22 at each C-rate were measured. The following Table 6 shows the capacity retention at 0.1 C and the capacity retention at 10 C in each Example.

TABLE 6

| | | Electrolyte | | Carbonate polymer | | | |
|---|---|---|---|---|---|---|---|
| | | | Blending | | Blending | Capacity | Capacity |
| | | | percentage/ | | percentage/ | retention at | retention at |
| | Plastic crystal | Type | mol % | Type | mol % | 0.1 C/% | 10 C/% |
| Example | [P12][FSA] | LiTFSA | 100 | PEC | 390.9 | 85.0 | 31.8 |
| 18 | | | | | | | |
| Example | [P12][FSA] | | | | 586.4 | 87.6 | 44.6 |
| 19 | | | | | | | |
| Example | [P12][FSA] | | | PPC | | 89.0 | 44.5 |
| 20 | | | | | | | |
| Example | [TEMA][FSA] | | | PEC | | 87.8 | 44.3 |
| 21 | | | | | | | |
| Example | [SBP][FSA] | | | | | 96.4 | 45.1 |
| 22 | | | | | | | |

As shown in Table 6, even when the plastic crystal contained in the solid electrolyte was one type, and when the plastic crystal, the lithium salt, and the carbonate polymer or a derivative thereof were contained, when the carbonate polymer or a derivative thereof was contained so that the proportion of its monomer unit was 293 mol % or more and 782 mol % or less relative to the plastic crystal, and when the lithium salt was contained at a proportion of 75 mol % or more relative to the plastic crystal, it was confirmed that the good rate characteristics were exhibited.

As shown in Table 6, even when the solid electrolyte was composed of the plastic crystal other than the [P12][FSA] plastic crystal or even when the carbonate polymer was other than polyethylene carbonate, and when the plastic crystal, the lithium salt, and the carbonate polymer or a derivative thereof were contained, when the carbonate polymer or a derivative thereof was contained so that the proportion of its monomer unit was 293 mol % or more and 782 mol % or less relative to the plastic crystal, and when the lithium salt was contained at a proportion of 75 mol % or more relative to the plastic crystal, it was confirmed that the good rate characteristics were exhibited.

Here, the following Table 7 shows a capacity retention at 0.1 C and a capacity retention at 10 C of lithium-ion secondary batteries using solid electrolytes of Comparative Examples 8 to 11. In Table 7, [P13][FSA] represents an ionic liquid composed of an N-methyl-N-propylpyrrolidinium cation and an FSA cation, and [EMI][FSA] represents an ionic liquid composed of a 1-ethyl-3-methylimidazolium cation and an FSA cation.

TABLE 7

| | | | Electrolyte | | Carbonate polymer | | | |
|---|---|---|---|---|---|---|---|---|
| | | | | Blending | | Blending | Capacity | Capacity |
| | | Plastic | | percentage/ | | percentage/ | retention at | retention at |
| | ionic liquid | crystal | Type | mol % | Type | mol % | 0.1 C/% | 10 C/% |
| Comparative | [P13][FSA] | — | LiTFSA | 100 | PEC | 390.9 | 77.3 | 68.8 |
| Example 8 | | | | | | | | |
| Comparative | [EMI][FSA] | — | | | | | — | — |
| Example 9 | | | | | | | | |
| Comparative | [P13][FSA] | — | | | | 586.4 | 65.5 | 60.1 |
| Example 10 | | | | | | | | |
| Comparative | | [P12][FSA] | | | | 390.9 | 83.7 | 24.0 |
| Example 11 | | | | | | | | |

As shown in Table 7, the solid electrolytes of Comparative Examples 8 to 11 contained the ionic liquid. In Comparative Examples 8 to 10, the plastic crystal was not contained, and the solid electrolyte of Comparative Example 11 contained the ionic liquid and the plastic crystal at the same amounts of mole. The lithium salts in Comparative Examples 8 to 11 were LiTFSA contained in the solid electrolyte within a range of 75 mol % or more relative to the plastic crystal. The carbonate polymers in Comparative Examples 8 to 11 were polyethylene carbonate (PEC) contained in the solid electrolyte so that the proportion of its unit monomer was within the range of 293 mol % or more and 782 mol % or less relative to the plastic crystal. Note that the lithium-ion secondary battery of Comparative Example 9 failed to be charged and discharged.

As understood from Comparative Examples 8 to 11, even when the carbonate polymer or a derivative thereof was contained at a proportion of 293 mol % or more and 782 mol % or less relative to the plastic crystal and even when the lithium salt was contained at a proportion of 75 mol % or more relative to the plastic crystal, it was confirmed that the solid electrolyte without the plastic crystal as the matrix phase exhibited a considerably poor capacity retention particularly at 0.1 C.

Even when the plastic crystal, the lithium salt, and the carbonate polymer or a derivative thereof were contained, even when the carbonate polymer or a derivative thereof was contained so that the proportion of its monomer unit was 293 mol % or more and 782 mol % or less relative to the plastic crystal, and even when the lithium salt was contained at a proportion of 75 mol % or more relative to the plastic crystal, it was confirmed that containing the ionic liquid in addition to the plastic crystal exhibited a considerably poor capacity retention at 0.1 C and capacity retention at 10 C.

### Example 23

A solid electrolyte of Example 23 was produced. This solid electrolyte contained the [P12][FSA] plastic crystal and the [P12][TFSA] plastic crystal at the same amounts of mole, LiTFSA at 100 mol % relative to the plastic crystal, polyethylene carbonate at 390.9 mol % relative to the plastic crystal, and triethylene glycol dimethyl ether among glycol diether compounds (glymes) at 40 mol % relative to the plastic crystal. The glyme was added into a vial bottle together with the plastic crystal, the lithium salt, and the carbonate polymer, and dissolved in acetonitrile. The manufacturing method except for the above was same as of the solid electrolyte of the other lithium-ion secondary batteries.

A capacity retention of the lithium-ion secondary battery using this solid electrolyte of Example 23 at each C-rate was measured. The following Table 8 shows the capacity retention at 0.1 C and the capacity retention at 10 C of the lithium-ion secondary battery using the solid electrolyte of Example 23.

TABLE 8

| | | Electrolyte | Carbonate polymer | Additive | | |
|---|---|---|---|---|---|---|
| | | Blending | Blending | Blending | | |
| | | percentage | percentage | percentage | Capacity | Capacity |
| | Plastic | relative to plastic | relative to plastic | relative to plastic | retention at | retention at |
| | crystal | crystal/mol % | crystal/mol % | crystal/mol % | 0.1 C/% | 10 C/% |
| Example | [P12][FSA] | LiTFSA | PEC | Glyme | 100 | 53.9 |
| 23 | [P12][TFSA] | 100 mol % | 390.9 mol % | 40 mol % | | |
| Example | [P12][FSA] | LiTFSA | PEC | — | 100 | 49.0 |
| 2 | [P12][TFSA] | 100 mol % | 390.9 mol % | | | |

As shown in Table 8, in Example 23, the glyme was further added in the solid electrolyte compared with Example 2. The lithium-ion secondary battery using this solid electrolyte of Example 23 had the improved capacity retention at 10 C compared with Example 2. That is, when the plastic crystal, the lithium salt, the carbonate polymer or a derivative thereof, and the glycol diether compound or the cyclic ether compound were contained, when the carbonate polymer or a derivative thereof was contained so that the proportion of its monomer unit was 293 mol % or more and 782 mol % or less relative to the plastic crystal, and when the lithium salt was contained at a proportion of 75 mol % or more relative to the plastic crystal, it was confirmed that further better rate characteristics were achieved.

### Examples 24 to 36

Solid electrolytes were produced by manufacturing methods in Examples 24 to 36 and Reference Examples 1 to 6. Into a vial bottle, the [P12][FSA] plastic crystal and the [P12][TFSA] plastic crystal were added at the same amounts of mole. Into the vial bottle, LiTFSA was added at 100 mol % relative to the plastic crystal. Into the vial bottle, polyethylene carbonate (PEC) or polypropylene carbonate (PPC) was added so that the proportion of the monomer unit was 586.4 mol % relative to the plastic crystal.

By using each of the solvents, solubility of the plastic crystal, the lithium salt, and the carbonate polymer was tested. In the solubility test, whether 1 mol of the plastic crystal was dissolved, whether 1 mol of the lithium salt was dissolved, and whether 5 mol of the carbonate polymer was dissolved, in 100 ml of the solvent, were visually checked. A temperature of the solvent was 25° C., and the dissolution target was added and then stirred for 12 hours.

The following Table 9 shows a type of the solvent and a type of the carbonate polymer used in the manufacturing method in Examples 24 to 36 and Reference Examples 1 to 6, and whether each of the plastic crystal, the lithium salt, and the carbonate polymer was dissolved. In the table, “◯” represents dissolution, and “x” represents no dissolution.

TABLE 9

| | | Type of | | | Solubility of |
|---|---|---|---|---|---|
| | | carbonate | Solubility of | Solubility of | carbonate |
| | Solvent type | polymer | plastic crystal | lithium salt | polymer |
| Example 24 | Propylene carbonate (PC) | PEC | ∘ | ∘ | ∘ |
| Example 25 | PC | PPC | ∘ | ∘ | ∘ |
| Example 26 | γ-Butyrolactone (GBL) | PEC | ∘ | ∘ | ∘ |
| Example 27 | GBL | PPC | ∘ | ∘ | ∘ |
| Example 28 | Dimethyl carbonate (DMC) | PPC | ∘ | ∘ | ∘ |
| Example 29 | Diethyl carbonate (DEC) | PPC | ∘ | ∘ | ∘ |
| Example 30 | Ethyl methyl carbonate (EMC) | PPC | ∘ | ∘ | ∘ |
| Example 31 | Ethylene carbonate (EC) | PEC | ∘ | ∘ | ∘ |
| Example 32 | EC | PPC | ∘ | ∘ | ∘ |
| Example 33 | DMC | PEC | ∘ | ∘ | ∘ |
| Example 34 | Anisol/Butyl butyrate | PPC | ∘ | ∘ | ∘ |
| Example 35 | Sulfolane | PEC | ∘ | ∘ | ∘ |
| Example 36 | Sulfolane | PPC | ∘ | ∘ | ∘ |
| Reference | Heptane | PEC | x | x | x |
| Example 1 | | | | | |
| Reference | Heptane | PPC | x | x | x |
| Example 2 | | | | | |
| Reference | Anisol | PEC | ∘ | x | x |
| Example 3 | | | | | |
| Reference | Anisol | PPC | ∘ | x | ∘ |
| Example 4 | | | | | |
| Reference | Butyl butyrate | PEC | ∘ | ∘ | x |
| Example 3 | | | | | |
| Reference | Butyl butyrate | PPC | ∘ | ∘ | x |
| Example 6 | | | | | |

As shown in Table 9, polar solvents were used in the manufacturing methods in Examples 24 to 36 except for Example 34, and a mixed solvent of anisole and butyl butyrate was used in the manufacturing method in Example 34. Anisole and butyl butyrate were mixed at a volume ratio of 1:1. In the manufacturing methods in Reference Examples 1 to 6, nonpolar solvents were used.

As shown in Table 9, each of 1 mol of the plastic crystal, 1 mol of the lithium salt, and 5 mol of the carbonate polymer were easily dissolved in 100 ml of the solvent in the manufacturing methods in Examples 24 to 36. In particular, as for use of a nonpolar solvent, even if a single nonpolar solvent failed to dissolve the lithium salt and the carbonate polymer, it was confirmed that the solid electrolyte was formed by, for example, mixing a solvent to dissolve the lithium salt such as butyl butyrate and a solvent to dissolve the carbonate polymer such as anisole, as in Example 34. Accordingly, it was confirmed that the polar solvents or the mixed solvent of anisole and butyl butyrate used in the manufacturing methods in Examples 24 to 36 was able to improve the productivity.

The solution of the plastic crystal, the lithium salt, and the carbonate polymer prepared by the manufacturing method in Examples 24 to 34 was added dropwise to a separator, an electrode for a negative electrode, and an electrode for a positive electrode. Drying under a vacuum environment at 50° C. for 2 hours and then drying under a vacuum environment at 100° C. for 12 hours were performed to evaporate the solvent. The electrode for the negative electrode had a current collector being copper foil, and an active material layer formed on the current collector and containing graphite. The electrode for the positive electrode had a current collector being aluminum foil, and an active material layer formed on the current collector and containing Li₁Ni_{0.6}Co_{0.2}Mn_{0.2}O₂. After the drying, the separator was sandwiched between the electrode for the negative electrode and the electrode for the positive electrode to produce a cell, and the cell was sealed with a laminated cell to complete a lithium-ion secondary battery. With this lithium-ion secondary battery, resistance of the solid electrolyte was measured. In addition, presence or absence of bubbles in the layer of the solid electrolyte was visually checked.

A method for measuring the resistance was as follows. Specifically, the produced laminated-cell-type lithium-ion secondary battery was charged and discharged at 0.1 C with one cycle and at 1.0 C with five cycles. Thereafter, the lithium-ion secondary battery was charged at 0.5 C until SOC 50%, and then a pulse was applied for 10 seconds at a current value of 0.3, 1.0, 2.0, or 3.0 C respectively, left for 5 minutes, and then the lithium-ion secondary battery was charged at each of the current values for 10 seconds. Here, SOC refers to a charge state where a full-charged state is 100% and a completely discharged state is 0%. The resistance value was calculated from a voltage drop and a slope of the current value in applying the pulse at each of the current value.

The results of the resistance measurement in each Example were as shown in the following Table 10.

TABLE 10

| | | Type of | |
|---|---|---|---|
| | | carbonate | Resistivity |
| | Solvent type | polymer | [Ω · cm²] |
| Example 24 | Propylene carbonate (PC) | PEC | 33.2 |
| Example 25 | PC | PPC | 35.5 |
| Example 26 | γ-Butyrolactone (GBL) | PEC | 32.4 |
| Example 27 | GBL | PPC | 34.7 |
| Example 28 | Dimethyl carbonate (DMC) | PPC | 35.1 |
| Example 29 | Diethyl carbonate (DEC) | PPC | 30.0 |
| Example 30 | Ethyl methyl | PPC | 32.2 |
| | carbonate (EMC) | | |
| Example 31 | Ethylene carbonate (EC) | PEC | 29.4 |
| Example 32 | EC | PPC | 31.5 |
| Example 33 | DMC | PEC | 32.8 |
| Example 34 | Anisol/Butyl butyrate | PPC | 34.7 |

As for presence or absence of bubbles, no bubble was observed in the solid electrolytes produced by the manufacturing methods in Examples 24 to 27, Examples 31 and 32, and Example 34. Accordingly, it was confirmed that the solvent of propylene carbonate, γ-butyrolactone, ethylene carbonate, or the mixed solvent of anisole and butyl butyrate reduced the amount of bubbles in the layer of the solid electrolyte.

1. A solid electrolyte, comprising a plastic crystal, a lithium salt, and a carbonate polymer or a derivative thereof, wherein:
the carbonate polymer or the derivative thereof is contained so that a proportion of a monomer unit of the carbonate polymer or the derivative thereof is 293 mol % or more and 782 mol % or less relative to the plastic crystal, and
the lithium salt is contained at a proportion of 75 mol % or more relative to the plastic crystal.

2. The solid electrolyte according to claim 1, wherein the solid electrolyte contains two or more types of the plastic crystals.

3. The solid electrolyte according to claim 1, wherein:
the solid electrolyte contains one type or two or more types of the plastic crystals,
one type, a plurality of types, or all types of the plastic crystals contain bis(fluorosulfonyl)amide, and
the bis(fluorosulfonyl)amide is contained at 20 mol % or more in anions of an entirety of the plastic crystal.

4. The solid electrolyte according to claim 1, further comprising a glycol diether compound or a cyclic ether compound.

5. The solid electrolyte according to claim 1, wherein the lithium salt is an ion-dissociative salt.

6. The solid electrolyte according to claim 1, wherein the carbonate polymer is one or two or more selected from polyethylene carbonate, polypropylene carbonate, polybutylene carbonate, polycyclohexene carbonate, polytrimethylene carbonate, polyhexamethylene carbonate, and bisphenol A-polycarbonate.

7. A power storage device, comprising:
the solid electrolyte according to claim 1; and
both electrodes disposed to face each other with the solid electrolyte sandwiched therebetween.

8. A method of manufacturing a solid electrolyte, comprising:
a step of mixing a plastic crystal, a lithium salt, and a carbonate polymer or a derivative thereof, wherein
in the step, the carbonate polymer or the derivative thereof is contained so that a proportion of a monomer unit of the carbonate polymer or the derivative thereof is 293 mol % or more and 782 mol % or less relative to the plastic crystal, and
in the step, the lithium salt is contained at a proportion of 75 mol % or more relative to the plastic crystal.

9. The method of manufacturing a solid electrolyte according to claim 8, wherein in the step, the plastic crystal, the lithium salt, and the carbonate polymer or the derivative thereof are added to a polar solvent.

10. The method of manufacturing a solid electrolyte according to claim 8, wherein in the step, the plastic crystal, the lithium salt, and the carbonate polymer or the derivative thereof are added to a mixed solvent of anisole and butyl butyrate.

11. The solid electrolyte according to claim 2, further comprising a glycol diether compound or a cyclic ether compound.

12. The solid electrolyte according to claim 2, wherein the lithium salt is an ion-dissociative salt.

13. The solid electrolyte according to claim 2, wherein the carbonate polymer is one or two or more selected from polyethylene carbonate, polypropylene carbonate, polybutylene carbonate, polycyclohexene carbonate, polytrimethylene carbonate, polyhexamethylene carbonate, and bisphenol A-polycarbonate.

14. A power storage device, comprising:
the solid electrolyte according to claim 2; and
both electrodes disposed to face each other with the solid electrolyte sandwiched therebetween.

15. The solid electrolyte according to claim 3, further comprising a glycol diether compound or a cyclic ether compound.

16. The solid electrolyte according to claim 3, wherein the lithium salt is an ion-dissociative salt.

17. The solid electrolyte according to claim 3, wherein the carbonate polymer is one or two or more selected from polyethylene carbonate, polypropylene carbonate, polybutylene carbonate, polycyclohexene carbonate, polytrimethylene carbonate, polyhexamethylene carbonate, and bisphenol A-polycarbonate.

18. A power storage device, comprising:
the solid electrolyte according to claim 3; and
both electrodes disposed to face each other with the solid electrolyte sandwiched therebetween.

19. The solid electrolyte according to claim 8, wherein the solid electrolyte contains two or more types of the plastic crystals.

20. The solid electrolyte according to claim 8, wherein:
the solid electrolyte contains one type or two or more types of the plastic crystals,
one type, a plurality of types, or all types of the plastic crystals contain bis(fluorosulfonyl)amide, and
the bis(fluorosulfonyl)amide is contained at 20 mol % or more in anions of an entirety of the plastic crystal.
